(19) United States
(12) Patent Application Publication
(10) Pub. No.: US 2015/0178115 A1
(43) Pub. Date: Jun. 25, 2015

(54) OPTIMAL ASSIGNMENT OF VIRTUAL MACHINES AND VIRTUAL DISKS USING MULTIARY TREE

(71) Applicants: SM Prakash Shiva, Bangalore (IN); Raman Ramteke Venkatesh, Bangalore (IN)

(72) Inventors: SM Prakash Shiva, Bangalore (IN); Raman Ramteke Venkatesh, Bangalore (IN)

(21) Appl. No.: 14/406,564

(22) PCT Filed: Jun. 22, 2012
(86) PCT No.: PCT/IN2012/000444

§ 371 Date: Dec. 9, 2014

(51) Int. Cl. G06F 9/455; G06F 13/10

(52) U.S. Cl. CPC G06F 9/45558; G06F 13/102; G06F 2009/45579

(57) ABSTRACT

A multiary tree represents relationships among physical storage units and host computing devices. Virtual machines are optimally assigned among the host computing devices, and virtual disks of the virtual machines are optimally assigned among the physical storage units, using and extending the multiary tree used on constraints. The constraints regard the physical storage units, the host computing devices, the virtual machines, and the virtual disks.

### BACKGROUND

Virtualization is a technique in which a virtual version of a computing resource is used in lieu of an actual, physical version of the computing resource, where a number of such virtual versions can be run on or hosted by the same physical computing resource. For example, a host computing device is a physical computing resource that can support a number of virtual machines, which are interacted with as if they were discrete physical computing devices themselves. Similarly, a physical storage unit is a physical computing resource that can support a number of virtual disks, which are likewise interacted with as if they were discrete physical storage units themselves.

### BRIEF DESCRIPTION OF THE DRAWINGS

FIG. 1 is a diagram of an example physical infrastructure including physical storage units and host computing devices, onto which an example virtual topology including virtual machines and virtual disks thereof is to be assigned.

FIGS. 2A and 2B are flowcharts of an example method for optimizing assignment of virtual machines among host computing devices and virtual disks among physical storage units using a multiary tree, in a scenario in which storage capacity usage of the physical storage units is a primary objective and optimal usage of the host computing devices is a secondary objective.

FIGS. 3A, 3B, 3C, and 3D are diagrams of an example multiary tree after various parts of the example method of FIGS. 2A and 2B have been performed.

FIG. 4 is a flowchart of an example method for optimizing assignment of virtual machines among host computing devices and virtual disks among physical storage units using a multiary tree, in a scenario in which optimal usage of the host computing devices is a primary objective and storage capacity usage of the physical storage units is a secondary objective.

FIGS. 5A and 5B are diagrams of an example multiary tree after various parts of the example method of FIG. 4 have been performed.

FIG. 6 is a flowchart of an example method for optimizing assignment of virtual machines among host computing devices and virtual disks among physical storage units using a multiary tree, which generalizes the example methods of FIGS. 2A and 2B and of FIGS. 4A and 4B.

### DETAILED DESCRIPTION

As noted in the background section, virtualization permits a number of virtual versions of a computing resource to run on or be hosted by the same physical computing resource. Virtualization is commonly employed with both virtual machines that virtualize computing devices like computers, as well as virtual disks that virtualize physical storage units that include storage devices such as hard disk drives. Such storage devices can be individual storage devices, as well as groups of storage devices that present themselves as individual logical devices. Examples of storage device groups include redundant array of independent disks (RAID) topologies and storage-area network (SAN) topologies.

A given computing system infrastructure can include a number of physical storage units that are interconnected with a number of host computing devices. Virtual machines are assigned to the host computing devices, and virtual disks of the virtual machines are assigned to the physical storage units. In such topologies, one of two scenarios typically dictates how these assignments are made. First, optimal usage of the storage capacity of the physical storage units can be the primary objective, and optimal usage of the host computing devices can be the secondary objective. Second, optimal usage of the host computing devices can be the primary objective, and optimal usage of the physical storage units can be the secondary objective.

In the first scenario, the virtual disks are assigned to the physical storage units and the virtual machines are assigned to the host computing devices to ensure foremost that the physical storage units are being optimally employed—that is, that the capacity of these storage units is being maximally and thus most efficiently employed. In this scenario, whether host computing device capacity usage suffers somewhat as a result is a lesser concern. Thus, in general, the virtual disks are first optimally assigned to the physical storage units to satisfy the primary objective of optimal physical storage unit usage, and then in consideration of these assignments the virtual machines are thereafter optimally assigned to the host computing devices to satisfy the secondary objective of optimal usage of the host computing devices.

In the second scenario, the virtual machines are assigned to the host computing devices and the virtual disks are assigned to the physical storage units to ensure foremost optimal usage of the host computing devices is optimal that is, that these host computing devices are being maximally utilized and thus such usage is most efficiently optimal. (I.e., that a maximum amount of the resources of the host computing devices is being used, such that a minimum of the host computing device resources is being under or not utilized.) In this scenario, whether physical storage unit capacity usage suffers somewhat as a result is a lesser concern. Thus, in general, the virtual machines are first optimally assigned to the host computing devices to satisfy the primary objective of optimal physical storage unit usage, and then in consideration of these assignments the virtual disks are thereafter optimally assigned to the physical storage units to satisfy the secondary objective of optimal usage of the host computing devices.

Techniques disclosed herein provide for optimal assignment of virtual machines to host computing devices and optimal assignment of virtual disks of these virtual machines to physical storage units using a multiary tree. The multiary tree represents relationships among the physical storage units and the host computing devices, and is used to optimize virtual machine and virtual disk assignments. Such optimization is performed regardless of whether the primary objective is optimal usage of the host computing devices or optimal physical storage unit usage, and whether the secondary objective is optimal physical storage unit usage or optimal usage of the host computing devices.

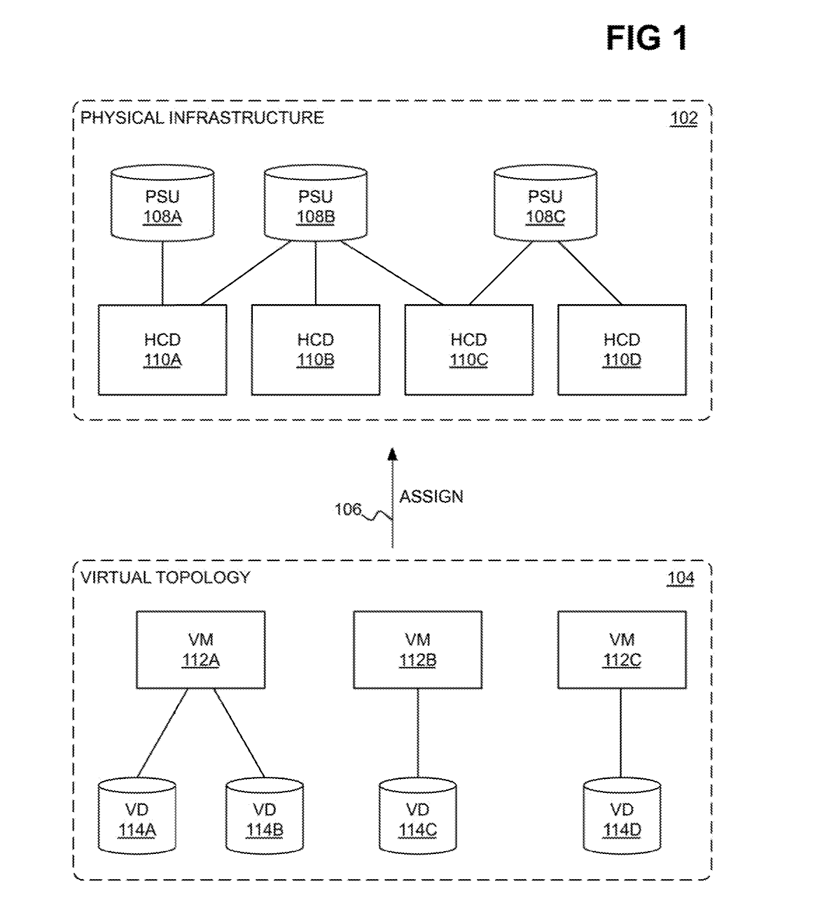

FIG. 1 shows an example physical infrastructure 102 onto which an example virtual topology 104 is to be assigned, as indicated by an arrow 106. The physical infrastructure 102 includes three physical storage units 108A, 108B, and 108C, collectively referred to as the physical storage units 108, which are interconnected to four host computing devices 110A, 110B, 110C, and 110D, collectively referred to as the host computing devices 110, as indicated in FIG. 1. There may be more or less than three physical storage units 108 and four host computing devices 110.

Each physical storage unit 108 is or includes one or more storage devices, like hard disk drives, solid state drives, and so on. As noted above, where a physical storage unit 108 includes more than one such storage device, the multiple storage devices can be organized in accordance with a RAID, SAN, or other type of topology. Each host computing device 110 is a computing device like a computer. As such, each computing device 110 typically includes hardware like one or more processors, hardware memory, as well as other types of hardware.

The physical storage unit 108A is communicatively interconnected to just the host computing device 110A. The physical storage unit 108B is communicatively interconnected to just host computing devices 110A, 110B, and 110C. The physical storage unit 108C is communicatively interconnected to just the host computing devices 110C and 110D.

The virtual topology 104 includes three virtual machines 112A, 112B, and 112C, collectively referred to as the virtual machines 112, and four virtual disks 114A, 114B, 114C, and 114D, which are collectively referred to as the virtual disks 114. There may be more or less than three virtual machines 112 and four virtual disks 114. The virtual machine 112A includes two virtual disks 114A and 114B, whereas the virtual machine 112B includes just one virtual disk 114C and likewise the virtual machine 112C includes just one virtual disk 114D.

Each virtual machine 112 is a software implementation of an actual physical machine—i.e., a computer or computing devices—that executes software as if it were a separate physical machine. Each virtual machine 112 typically includes its own operating system, which is referred to as a guest operating system, and which governs just the virtual machine 112, and not other virtual machines 112 that may be running on the same host computing device 110 in question. Each virtual disk 114 emulates a physical storage unit, such as a hard disk drive or a collection of hard disk drives. Each virtual disk 114 may be considered a disk image in some nomenclatures.

In the assignment process represented by the arrow 106, the virtual machines 112 are assigned to the host computing devices 110 such that the latter host the former, and the virtual disks 114 are assigned to the physical storage units 108 again such that the latter host the former. At a minimum, the assignment process ensures that the relationships between virtual machines 112 and the virtual disks 114 are maintained when assigning the former to the host computing devices 110 and the latter to the physical storage units 108. For example, the virtual machine 112B cannot be assigned to the host computing device 110D if the virtual disk 114C of this virtual machine 112B is assigned to the physical storage unit 108B, because the host computing device 1100 is not communicatively connected to the physical storage unit 108B.

Beyond these minimum dictates, the assignment process represented by the arrow 106 attempts to optimize on which host computing device 110 each virtual machine 112 is placed and on which physical storage unit 108 each virtual disk 114 is placed in accordance with a desired scenario. As noted above, in a first scenario, optimal usage of the storage capacity of the physical storage units 108 is the primary objective, and optimal usage of the host computing devices 110 is the secondary objective. In a second scenario, optimal usage of the host computing devices 110 is the primary objective, and optimal usage of the physical storage units 108 is the secondary objective.

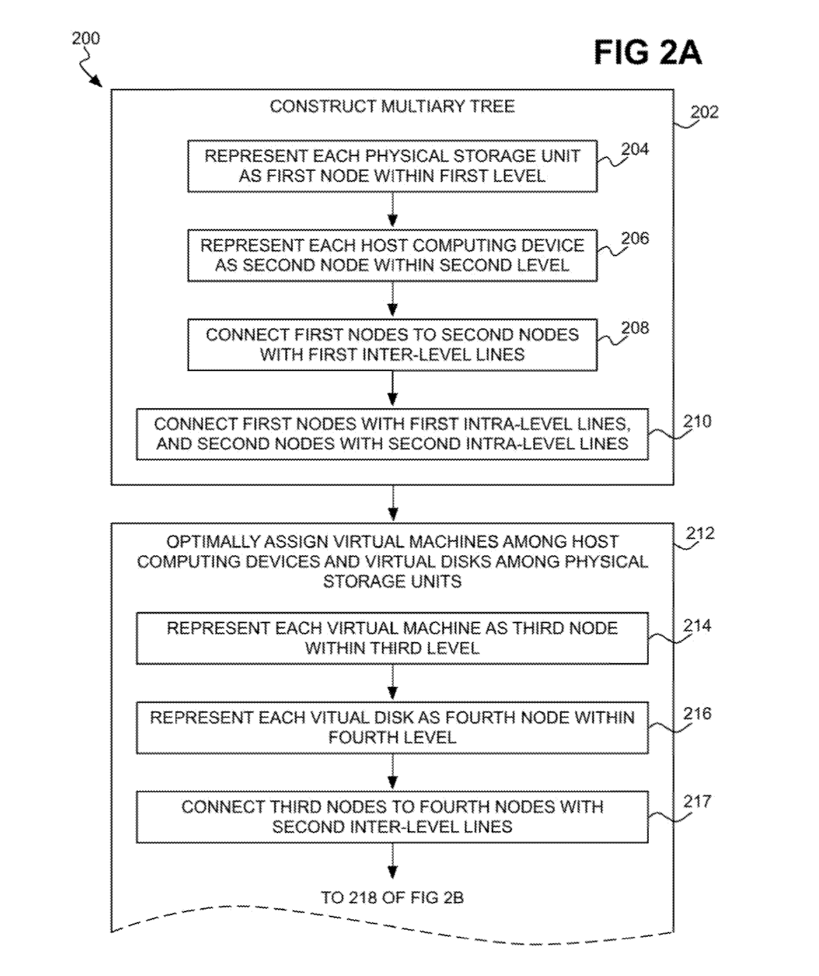

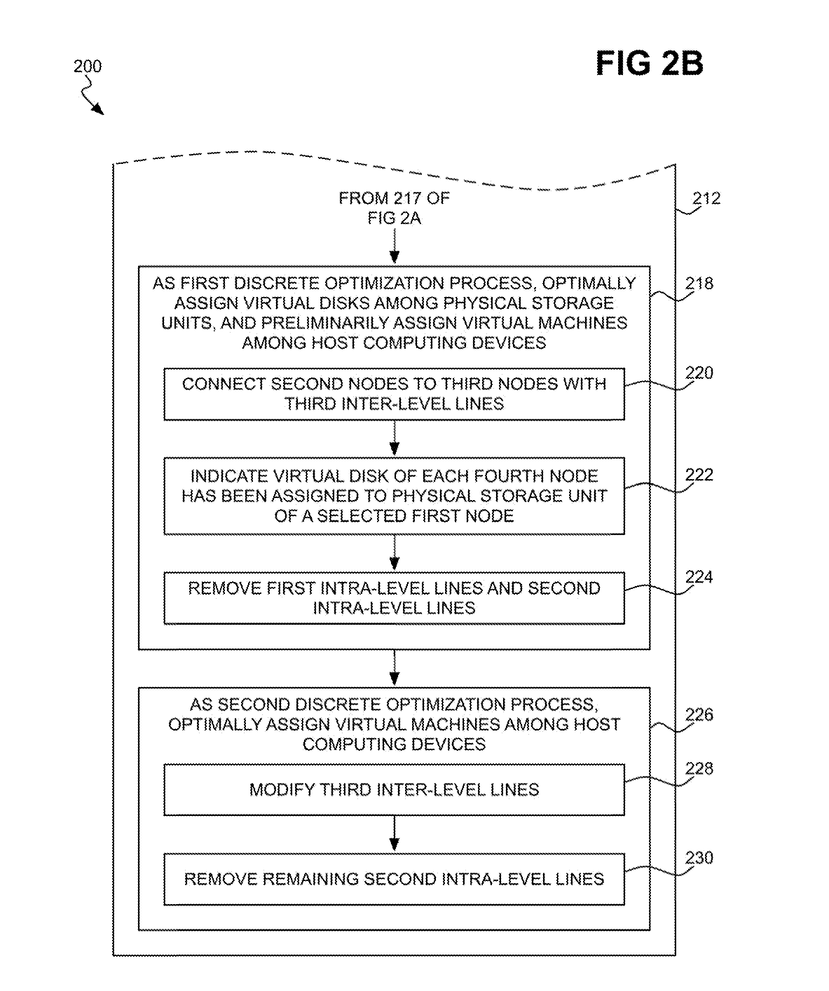

FIGS. 2A and 28 show an example method 200 for optimizing the assignment of virtual machines 112 among the host computing devices 110 and the virtual disks 114 among the physical storage units 108 using a multiary tree, in the scenario in which storage capacity usage of the physical storage units 108 is the primary objective and optimal usage of the host computing devices 110 is the secondary objective. The method 200 can be implemented as one or more computer programs stored on a computer-readable data storage medium and executable by a processor. The processor can be part of a computing device, such as one of the host computing devices 110, or another computing device.

Referring first to FIG. 2A, a multiary tree is constructed (202). A multiary tree is a tree data structure that includes a number of nodes organized over a number of levels. Each node within each level except a bottom-most level connects to one or more nodes within the level immediately below. The tree is a multi-ary tree, as opposed to being strictly a binary tree, for instance, because the number of nodes to which each node within each level except a bottom-most level is connected is not restricted to any particular number.

The multiary tree is constructed first to represent the physical storage units 108, the host computing devices 110, and relationships therebetween and thereamong. As such, each physical storage unit 108 is represented as a first node within a first, top-most level of the tree (204), and each host computing device 110 is represented as a second node within a second level of the tree immediately below the first level (206). The first nodes and the second nodes are connected with first inter-level lines in accordance with the connective relationships between the physical storage units 108 and the host computing devices 110 (208). As such, each first inter-level line connects a first node to a second node indicating that the host computing device 110 represented by the former is associated with the physical storage unit 108 represented by the latter.

The first nodes are connected among one another with first intra-level lines, and the second nodes are connected among one another with second intra-level lines (210), again in accordance with the connective relationships between the physical storage units 108 and the host computing devices 110. Each first inter-level line connects two first nodes indicating that the physical storage units 108 represented by these first nodes are shared by one or more of the host computing device 110. Each second inter-level line connects two second nodes indicating that the host computing devices 110 represented by these second nodes share one or more of the physical storage units 108.

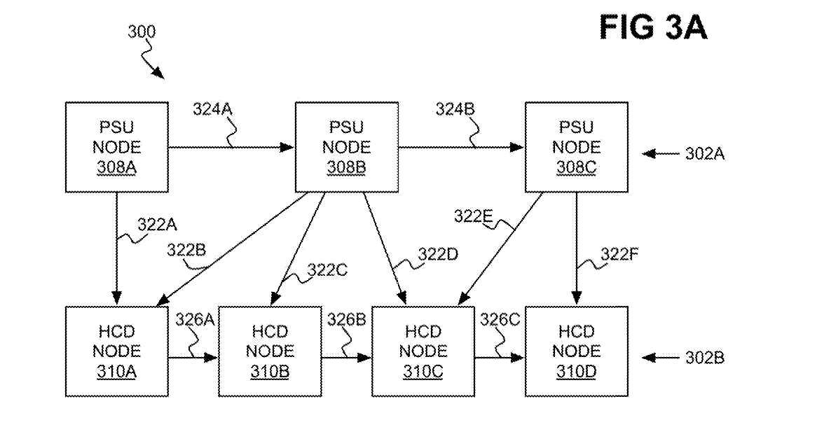

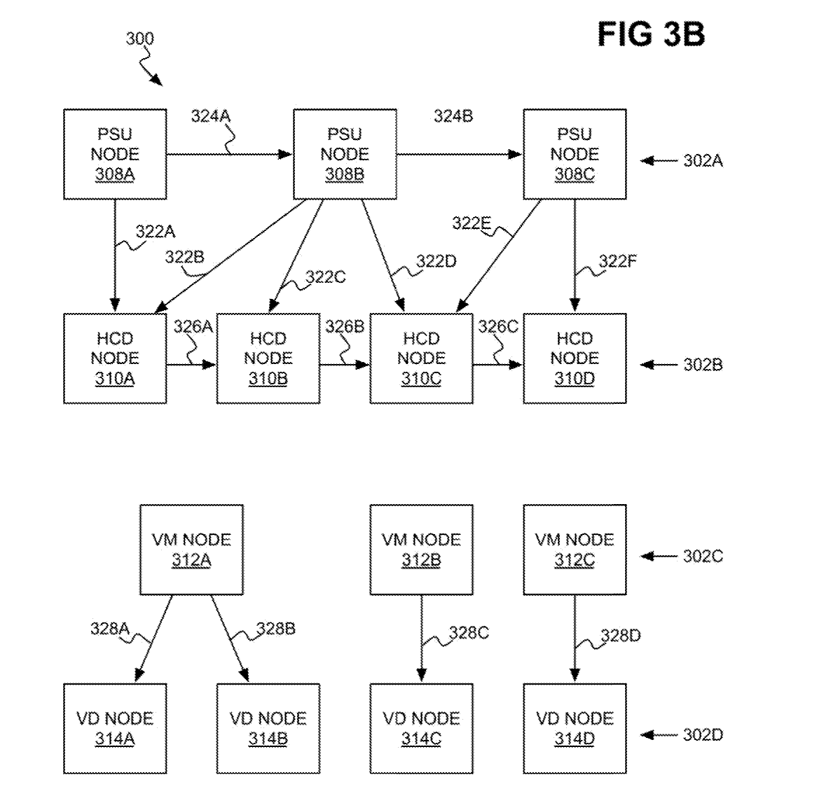

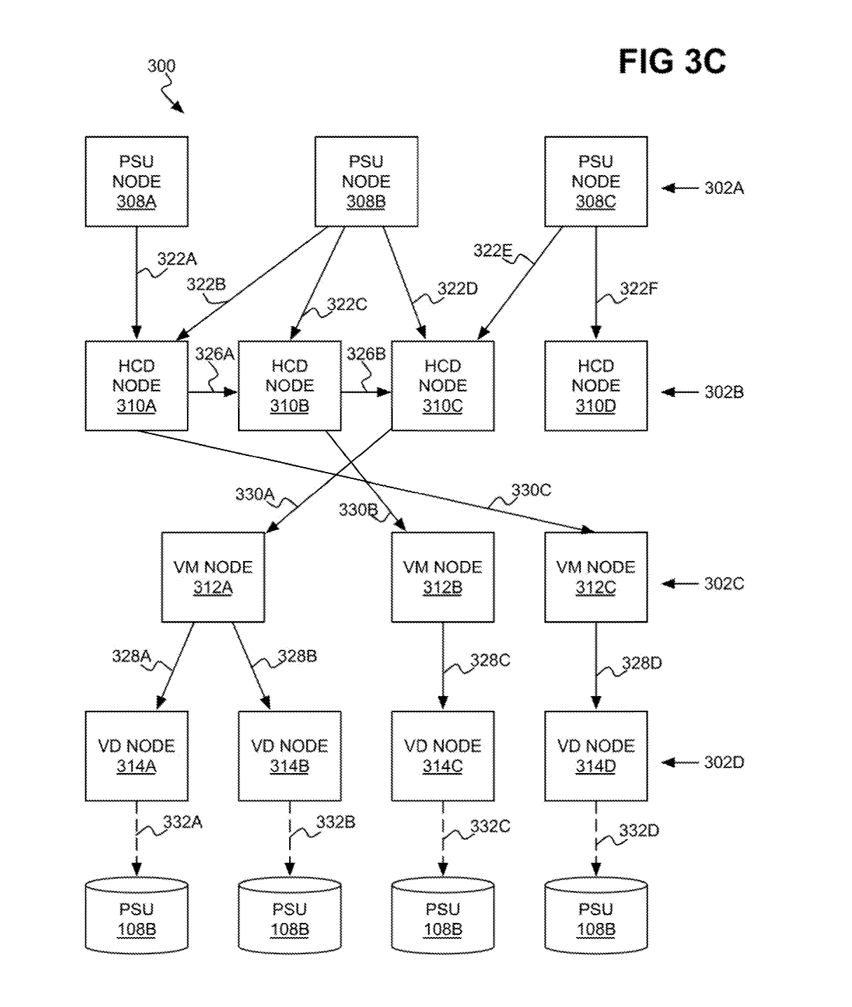

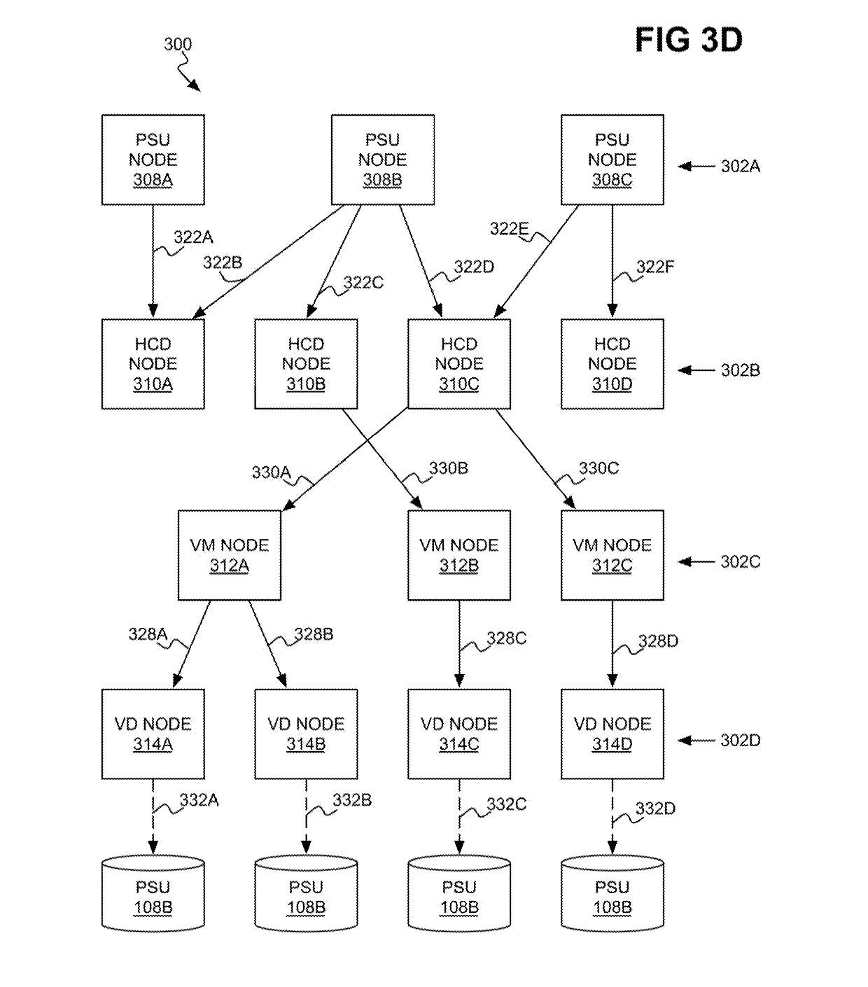

FIG. 3A shows an example multiary tree 300 representing the physical infrastructure 102 after part 202 of the method 200 has been performed. The multiary tree 300 includes first, or PSU, nodes 308A, 308B, and 308C representing the physical storage units 108A, 108B, and 108C, respectively, and collectively referred to as the first nodes 308, within a first or top-most level 302A. The multiary tree 300 includes second, or HCD, nodes 310A, 310B, 310C, and 310D representing the host computing devices 110A, 110B, 110C, and 110D, respectively, and collectively referred to as the second nodes 310, within a second level 302B immediately below the first level 302A.

First inter-level lines 322A, 322B, 322C, 322D, 322E, and 322F, collectively referred to as the first inter-level lines 322, interconnect the first nodes 308 to the second nodes 310 consistent with the connective relationships between the physical storage units 108 and the host computing devices 110. First intra-level lines 324A and 324B, collectively referred to as the first intra-level lines 324, interconnect the first nodes 308. Second intra-level lines 326A, 326B, and 326C, collectively referred to as the second intra-level lines 326, interconnect the second nodes 310.

Each first intra-level line 324 connects two adjacent first nodes 308 to indicate that the physical storage units 108 represented by these two first nodes 308 are shared by one or more of the host computing devices 110. For example, the first intra-level line 324A connects first nodes 308A and 308B, because the physical storage units 108A and 208B represented by these first nodes 308A and 308B are shared by the host computing device 110A. Similarly, each second intra-level line 326 connects two adjacent second nodes 310 to indicate that the host computing devices 110 represented by these two second nodes 310 share one or more of the host computing devices 110. For example, the second intra-level line 326C connects second nodes 310C and 310D, because the host computing devices 110C and 110D represented by these second nodes 310C and 310D share the physical storage unit 108C.

Referring back to FIG. 2A, the virtual machines 112 are optimally assigned among the host computing devices 110 and the virtual disks 114 of the virtual machines 112 are optimally assigned among, the physical storage units 108 using the multiary tree 300 (212), where storage capacity usage of the physical storage units 108 is the primary objective and optimal usage of the host computing devices 110 is the secondary objective. This first entails adding nodes within the multiary tree 300 to represent the virtual machines 112 and the virtual disks 114, and interconnecting these nodes.

Specifically, each virtual machine 112 is represented as a third node within a third level of the multiary tree 300 immediately below the second level 302B (214). Each virtual disk 114 is represented as a fourth node within a fourth level of the multiary tree 300 immediately below the third level (216). The third nodes are connected to the fourth nodes with second inter-level lines in accordance with the relationships between the virtual machines 112 and the virtual disks 114 (217). As such, each second inter-level line connects a third node to a fourth node indicating that the virtual disk 114 represented by the fourth node is associated with the virtual machine 112 of the third node.

FIG. 3B shows the example multiary tree 300 of FIG. 3A after parts 214, 216, and 217 of the method 200 have been performed. The multiary tree 300 thus now includes third, or VM, nodes 312A, 312B, and 312C representing the virtual machines 112A, 112B, and 112C, respectively, and collectively referred to as the third nodes 312, within a third level 302C immediately below the second level 302B. The multiary tree 300 also now includes fourth, or VD, nodes 314A, 314B, 314C, and 314D representing the virtual disks 114A, 114B, 114C, and 114D, respectively, and collectively referred to as the fourth nodes 314, within a fourth level 302D immediately below the third level 302C.

Second inter-level lines 328A, 328B, 328C, and 328D, collectively referred to as the second inter-level lines 328, interconnect the third nodes 312 to the fourth nodes 314 consistent with the relationships between the virtual machines 112 and the virtual disks 114. For example, the second inter-level lines 328A and 328B connect the fourth nodes 314A and 3148 to the third node 312A, because the virtual disks 114A and 114B represented by the fourth nodes 314A and 3146 are associated with the virtual machine 112A represented by the third node 312A. The virtual disks 114A and 114B are said to be “of” the virtual machine 112A, in that the virtual machine 112A can be said to include the virtual disks 114A and 114B.

Referring next to FIG. 2B, in a first discrete optimization process, the virtual disks 114 are optimally assigned among the physical storage units 108 and the virtual machines 112 are preliminarily assigned among the host computing devices 110 (218), using and extending the multiary tree 300. In general, the assignment process of part 212 includes two discrete optimization processes. The optimization processes are discrete in that they are performed separately, where one process is first performed, and then the other process is performed.

The first discrete optimization process assigns the virtual disks 114 optimally among the physical storage units 108, but assigns the virtual machines 112 just preliminarily among the host computing devices 110 due to the primary and secondary objectives of the scenario that the method 200 reflects. Because the primary objective is storage capacity usage or utilization of the physical storage units 108, the foremost consideration is assigning the virtual disks 114 among the physical storage units 108 to achieve this objective. As such, the first discrete optimization process assigns the virtual disks 114 among the physical storage units 108 so that this objective is primarily met. As part of this process, the virtual machines 112 are inherently or have to be assigned among the host computing devices 110, but this assignment is preliminary.

The first discrete optimization process can be an opportunity index approach in which a number of parameters and constraints are considered in optimally assigning the virtual disks 114 among the physical storage units 108 and in preliminarily assigning the virtual machines 112 among the host computing devices 110. The parameters include the storage size of each virtual disk 114, the storage capacity of each physical storage unit 108. The parameters also include the peak resource utilization of each virtual machine 112, in terms of processing power, memory, and so on, and the resource capacity of each host computing device 110.

The constraints can include one or more of the following. A first constraint is a service level agreement (SLA) mandating performance of one or more of the virtual machines 112. An SLA can be derived from the business services, business applications, or cluster with which the virtual machines 112 in question are associated. For instance, an SLA of a virtual machine 112 may be categorized as platinum, gold, or silver, in that order. As an example, a virtual machine 112 hosting a business service relating to online gaming may have a higher SLA than a virtual machine 112 hosting a consumer service relating to electronic mail.

A second constraint is an SLA mandating performance of one or more of the virtual disks 114. The SLA of a virtual disk 114 can be derived from the SLA of the virtual machine 112 with which the virtual disk 114 is associated, how critical the data stored on the virtual disk 114 is, and the expected storage input/output (I/O) performance of the virtual disk 114. For example, a virtual disk 114 associated with a virtual machine 112 hosting a business service relating to online gaming may have a high SLA to ensure better I/O performance and redundancy in the case of failure. The SLA of a virtual disk 114 may also be categorized as platinum, gold, or silver, in that order.

A third constraint is an SLA mandating performance of one or more of the physical storage units 108. The SLA of a physical storage unit 108 can be derived from the expected uptime and performance of the physical storage unit, as well as the redundancy needed, and may similarly be categorized as platinum, gold, or silver, in that order. For example, a platinum SLA for a physical storage unit 108 may specify redundant storage, 99.5+% uptime, and high performance, whereas a gold SLA may specify redundant storage, 99.5+% uptime, but medium performance. By comparison, a silver SLA may specify non-redundant storage, 97+% uptime, and medium performance.

A fourth constraint mandates that the virtual disks 114 associate with a virtual machine 112 are to be assigned to certain specified physical storage units 108. A fifth constraint mandates that the virtual disks 114 associated with the virtual machines 112 assign to a given host computing device 110 are to be assigned to certain specified physical storage units 108. A sixth constraint mandates that certain virtual disks 114 are to be assigned to the same physical storage unit 108, whereas a seventh constraint mandates that certain virtual disks 114 are not to be assigned to the same physical storage unit 108.

In the description that follows, the following assumptions are made about the physical infrastructure 102 and the virtual topology 104, as an example. The virtual machine 112A has a peak processor requirement of twenty gigahertz (GHz), the virtual machine 112B has a peak processor requirement of three GHz, and the virtual machine 112C has a peak processor requirement of two GHz. Furthermore, the virtual machines 112A and 112C have complementary workloads, in that the virtual machine 112A is operational during the day, whereas the virtual machine 112C is operational at night. The virtual disks 114A and 114B of the virtual machine 112A require five gigabytes (GB) of storage each the virtual disk 114C of the virtual machine 112B requires two GB of storage, and the virtual disk 114D of the virtual machine 112C requires seven GB of storage.

The host computing device 110A associated with the physical storage units 108A and 108B has a processor speed of two GHz, and the host computing device 110B associate with the physical storage unit 108B has a processor speed of four GHz. The host computing device 110C associated with the physical storage units 108B and 108C has a processor speed of twenty GHz, and the host computing device 110D associated with the physical storage unit 108C has a processor speed of five GHz. The physical storage unit 108A has a storage capacity of fifteen GB, the physical storage unit 108B has a storage capacity of twenty GB, and the physical storage unit 108C has a storage capacity of five GB.

Furthermore, the physical infrastructure 102 and the virtual topology 104 have the following constraints. None of the virtual machines 112 has an SLA. However, the virtual disk 114C has a platinum SLA, although none of the other virtual disks 114 has an SLA. The physical storage units 108A and 108B have platinum SLAs, and the physical storage unit 108C has a silver SLA. The virtual disks 114A and 114B associated with the virtual machine 112A are to be placed on the same physical storage unit 108, and the virtual disk 114D is to be placed on the physical storage unit 108C in particular.

As noted above, the first discrete optimization process can be an opportunity index approach that considers the parameters and constraints regarding the physical infrastructure 102 and the virtual topology 104 in optimally assigning the virtual disks 114 among the physical storage units 108 and in preliminarily assigning the virtual machines 112 among the host computing devices 110, by using and extending the multiary tree 300. An opportunity index approach is an analytical approach that locates a mapping of the virtual disks 114 to the physical storage units 108 to satisfy the primary objective of maximally and thus most efficiently use the storage capacity of the physical storage units 108, in consideration of the parameters and the constraints. This mapping also results in a (preliminary) mapping of the virtual machines 112 to the host computing devices 110.

Different types of opportunity index approaches can be employed, but in general, such approaches may construct various tables to identify mappings that satisfy the primary objective in consideration of the parameters and the constraints. For instance, an opportunity index approach that can be used is described in the previously filed U.S. patent application entitled “Computer workload capacity estimation,” filed on Dec. 16, 2010, and assigned patent application Ser. No. 12/970,824. Other approaches can also be employed however, however.

As an example of such an opportunity index approach, due to the constraint that virtual disks 114A and 114B have to reside on the same physical storage unit 108, the host computing device 110C can be selected for placement of the virtual machine 112A that includes the virtual disks 114A and 114B. The virtual machine 112A has a processor requirement of twenty GHz, which can be supported by the host computing device 110C, because the host computing device 110C has a processor speed of twenty GHz. Furthermore, the physical storage unit 108B with which the host computing device 110C is associated can support the virtual disks 114A and 114B, because the latter have a total storage requirement of ten GB and the former has a storage capacity of twenty GB.

The virtual machines 112B and 112C having the virtual disks 114C and 114D can be assigned to the host computing device 110B or 110D. This is because, first, each of these host computing devices 110B and 110D can satisfy the total processor requirements of the virtual machines 112B and 112C. Second, physical storage units 108B and 108C with which the host computing devices 110B and 110D are associate can each satisfy the total storage requirements of the virtual disks 114C and 114D.

The result of this first discrete optimization process is that the virtual disks 114A and 114B are placed on the physical storage unit 108B, and their associated virtual machine 112A is hosted by the host computing device 110C that is associated with the physical storage unit 108B. The virtual disk 114C is placed on the physical storage unit 108B because it has a platinum SLA and thus has to be placed on a physical storage unit 108 that has a matching SLA. The virtual machine 112B associated with the virtual disk 114C is placed on the host computing device 110B, because, first, the host computing device 110B is communicatively connected to the physical storage unit 108B. Second, the host computing device 110A cannot host the virtual machine 112B even though the host computing device 110A is also connected to the physical storage unit 108B, because it has insufficient processor speed. Third, the host computing device 110C cannot host the virtual machine 112B even though it also is connected to the physical storage unit 108B, because the host computing device 110C has already had the virtual machine 112A placed thereon, and there is insufficient processor speed remaining to further host the virtual machine 112B.

The virtual disk 114D is placed on the physical storage unit 108B because of the constraint dictating this placement. The virtual machine 112C associated with the virtual disk 114D is placed on the host computing device 110A that is communicatively connected to the physical storage unit 108B. The virtual machine 112C cannot be placed on the host computing device 110B even though the host computing device 110B is also connected to the physical storage unit 108B, because it has already had the virtual machine 112B placed thereon, and there is insufficient processor speed remaining to further host the virtual machine 112C. Similarly, the virtual machine 112C cannot be placed on the host computing device 110C even though it is also connected to the physical storage unit 108B, because the host computing device 110C has already had the virtual machine 112A placed thereon, and there is insufficient processor speed remaining to further host the virtual machine 112C.

Performance of the first discrete optimization process uses the multiary tree 300 that has been constructed to navigate among the nodes 308, 310, 312, and 314 to obtain information regarding the physical storage units 108, the host computing devices 110, the virtual machines 112, and the virtual disks 114. Each node 308, 310, 312, and 314 thus stores the parameters and constraints regarding its associated physical storage unit 108, host computing device 110, virtual machine 112, or virtual device 114 in question. As the virtual disks 114 are assigned to the physical storage units 108 and the virtual machines 112 are assigned to the host computing devices 110, the multiary tree 300 is extended and updated to reflect these mappings.

It is noted in this respect that the first discrete optimization process takes into account the first intra-level lines 324 connecting the first nodes 308 and the second intra-level lines 326 connecting the second nodes 310. The first intra-level lines 324 are considered insofar as these lines 324 indicate which of the power storage units 108 are shared among the host computing devices 110. Similarly, the second intra-level lines 326 are considered insofar as these lines 326 indicate which of the host computing devices 110 share power storage units 108. This information is used within the first discrete optimization process to assign the virtual disks 114 to the physical storage units 108 and the virtual machines 112 to the host computing devices 110, as has been described by example above.

The first discrete optimization process extends the multiary tree 300 as follows. The second nodes 310 representing the host computing devices 110 are connected to the third nodes 312 representing the virtual machines 112 in accordance with the mapping of the virtual machines 112 to the host computing devices 110, via third inter-level lines (220). Each third inter-level line connecting a second node 310 to a third node 312 indicates that the virtual machine 112 represented by the third node 312 has been preliminarily assigned to the host computing device 110 represented by the second node 310.

The multiary tree 300 is also extended or updated to indicate the assignment of the virtual disk 114 represented by each fourth node 314 to the physical storage unit 108 of a first node 308 (222). The first intra-level lines 324 are removed from the multiary tree 300, and potentially one or more of the second intra-level lines 326 as well (224). The first intra-level lines 324 and the second intra-level lines 326 are removed to indicate restrictions in the second discrete optimization process that follows.

A first intra-level line 324 between a pair of first nodes 308 effectively indicates that a virtual disk 114 assigned to the physical storage unit 108 of the left-most first node 308 of the pair can be moved to the physical storage unit 108 of the right-most first node 308 of the pair. The first intra-level lines 324 are removed, therefore, because the first discrete optimization process has optimally assigned the virtual disks 114 to the physical storage units 308. As such, the second discrete optimization process cannot modify these assignments.

A second intra-level line 326 between a pair of second nodes 310 effectively indicates that a virtual machine 112 assigned to the host computing device 110 of the left-most second node 310 of the pair can be moved to the host computing device 110 of the right-most second node 310 of the pair. If no virtual machine 112 was preliminarily assigned to a host computing device 110 in the first discrete optimization process, then the second node 310 representing the host computing device 110 has any second intra-level line 326 connecting to it removed. This prevents the second discrete optimization process from considering assignment of a virtual machine 112 to this host computing device 110 when optimizing placement of the virtual machines 112 on the host computing devices 110, to conserve the number of host computing devices 110 on which the virtual machines 112 are placed.

FIG. 3C shows the example multiary tree 300 of FIG. 3B after parts 218, 220, 222, and 224 of the method 200 have been performed. The military tree 300 thus now includes third inter-level lines 330A, 330B, and 330C, collectively referred to as the third inter-level lines 330, and which interconnect the second nodes 310 with the third nodes 312 consistent with the preliminary mappings of the virtual machines 112 to the host computing devices 110. In the example, then, the virtual machine 112A has been preliminarily assigned to the host computing device 110C, such that the third inter-level line 330A connects the corresponding third node 312A to the corresponding second node 310C. Similarly, the third inter-level line 330B connects the second node 310B to the third node 312B and the third inter-level line 330C connects the second node 310A to the third node 312C, because the virtual machines 112B and 112C have been preliminarily assigned host computing devices 110B and 110A, respectively.

The multiary tree 300 includes lines 332A, 332B, 332C, and 332D corresponding to the fourth nodes 314A, 314B, 314C, and 314D, respectively, and which are collectively referred to as the lines 332. The lines 332 indicate the optimal mappings of the virtual disks 114 represented by the fourth nodes 314 to the physical storage units 108. In the example, each virtual disk 114 has been optimally assigned to the same physical storage unit 108B. Therefore, each line 332 indicates that a corresponding fourth node 314 has been assigned to the physical storage unit 108B. The first intra-level lines 324 of FIG. 3B have been removed from FIG. 3C, and the second intra-level line 326C of FIG. 3B has also been removed from FIG. 3C. This is because no virtual machines 112 have been assigned to the host computing device 110D represented by the second node 310D to the right of the second intra-level line 326C in FIG. 3B, which is indicated in FIG. 3C insofar as no third inter-level line 330 is connected to this second node 310D.

Referring back to FIG. 2B, once the first discrete optimization process has been performed, the second discrete optimization process is performed to optimally assign the virtual machines 112 among the host computing devices 110 (226). The second discrete optimization process is performed under the additional constraint that the assignment of the virtual disks 114 among the physical storage units 108 achieved within the first discrete optimization process remains unchanged, as noted above. The first discrete optimization process has already assigned the virtual disks 114 among the physical storage units 108 in an optimal manner, such that the primary objective of storage capacity usage of the physical storage units 108 has been satisfied. Therefore, the purpose of the second discrete optimization process is to satisfy the secondary objective of optimal usage of the host computing devices 110 without affecting the already achieved satisfaction of the primary objective.

Like the first discrete optimization process, the second discrete optimization process can be an opportunity index approach in which the parameters and constraints noted above are considered in optimally assigning the virtual machines 112 among the host computing devices 110, but without modifying the optimal assignments of the virtual disks 114 to the physical storage units 108. The second discrete optimization process is performed in relation to sub-trees of the multiary tree 300. The multiary tree 300 is divided into sub-trees based on the second intra-level lines 326 that remain after removal in part 224. Specifically, the second nodes 310 are grouped into groups in which no second node 310 of any group is connected to a second node 310 in another group.

A sub-tree of the multiary tree 300 is said to correspond to each such group, and includes the first, second, third, and fourth nodes 308, 310, 312, and 314 that are connected to any second node 310 within the group in question. The second discrete optimization process can be performed in relation to each such sub-tree that includes second nodes 310 representing host computing devices 110 to which virtual machines 112 have been assigned. If a sub-tree includes second nodes 310 representing host computing devices 110 to which no virtual machine 112 has been assigned, then the sub-tree is not considered, such that the corresponding group of second nodes 310 is effectively discarded. In the example that is being described, this means that the host computing device 1100 is not considered in the second discrete optimization process, because no virtual machine 112 has been assigned to it.

The second discrete optimization process can adjust the assignment of virtual machines 112 to the host computing devices 110 such that complementary resource trends are considered. For example, as noted above, the virtual machine 112A is operational during the day, whereas the virtual machine 112C is operational at night. Therefore, the virtual machines 112A and 112C can both be placed on the host computing device 110C, even though the twenty-two GHz sum of the peak processor requirements of the virtual machines 112A and 112C exceeds the twenty GHz processor speed of the host computing device 110C. This is because the virtual machines 112A and 112C are not operative at the same time, and the processor requirement of neither virtual machine 112A nor 112C individually exceeds the processor speed of the host computing device 110C.

Therefore, the virtual machine 112C is moved in the second discrete optimization process from the host computing device 110A on which it was placed in the first discrete optimization process to the host computing device 110C. Stated another way, the host computing device assignment of the virtual machine 112C is modified in the second discrete optimization process. This adjustment does not affect the optimal assignment of the virtual disk 114D of the virtual machine 112C to the physical storage unit 108B realized in the first discrete optimization process, which the second discrete optimization process is not permitted to change. Moving the virtual machine 112C from the host computing device 110A to the host computing device 110C does not affect the assignment of the virtual disk 114D to the physical storage unit 108B, because the host computing device 110C is communicatively connected to the physical storage unit 108B no differently than the host computing device 110A is.

As with the first discrete optimization process, performance of the second discrete optimization process uses the multiary tree 300 that has been constructed to navigate among the nodes 308, 310, 312, and 314 to obtain information regarding the physical storage units 108, the host computing devices 110, the virtual machines 112, and the virtual disks 114. As the virtual machines 112 have their assignments to the host computing devices 110 modified, the multiary tree 300 is extended and updated to reflect these adjustments. In this respect, the second discrete optimization process takes into account the remaining second intra-level lines 326 connecting the second nodes 310, at least insofar as these lines 326 are used to divide the multiary tree 300 into sub-trees, as noted above.

The second discrete optimization process extends the multiary tree 300 as follows. The third inter-level lines 330 connecting the third nodes 312 to the fourth nodes 314 can be modified to change the fourth nodes 314 to which the third nodes 312 are connected (228). For such a third inter-level line 330 that has been modified, this indicates that the virtual machine 112 represented by a third node 312 to which the third inter-level line 330 is connected has been optimally reassigned to a different host computing device 110, as compared to the host computing device 110 to which the virtual machine 112 was preliminarily assigned. This different host computing device 110 is represented by the second node 310 to which the third inter-level line 330 in question is now connected.

The remaining second intra-level lines 326 are removed at the end of the second discrete optimization process as well (230). As has been described, a second intra-level line 326 between a pair of second nodes 310 effectively indicates that a virtual machine 112 assigned to the host computing device 110 of the left-most second node 310 of the pair can be moved to the host computing device 110 of the right-most second node 310 of the pair. However, once the second discrete optimization process is finished, the virtual machines 112 have been optimally assigned to the host computing devices 110 in accordance with the secondary objective. Therefore, since no further reassignments are to be done, this means that the second intra-level lines 326 can be removed.

FIG. 3D shows the example multiary tree of FIG. 3C after parts 226, 228, and 230 of the method 200 have been performed. The third inter-level line 330C that had connected the third node 312C to the second node 310A in FIG. 3C now connects the third node 312C to the second node 310C. This indicates that the virtual machine 112C represented by the third node 312C has been optimally reassigned to the host computing device 110C represented by the second node 310C. Furthermore, the remaining second intra-level lines 326A and 326B in FIG. 3C have been removed.

At the end of the first discrete optimization process, the virtual topology 104 was mapped to the physical infrastructure 102 such that one physical storage unit 108C and three host computing devices 110A, 110B, and 110C were used. The second discrete optimization process further refined this mapping. As such, after the end of the second discrete optimization process, one physical storage unit 108C and just o host computing devices 110B and 110C are used.

The method 200 that has been described optimizes the assignment of virtual machines 112 among the host computing devices 110 and the virtual disks 114 among the physical storage units 108 in the scenario in which storage capacity usage of the physical storage units 108 is the primary objective and optimal usage of the host computing devices 110 is the secondary objective. In another scenario, these objectives are reversed, such that optimal usage of the host computing devices 110 is the primary objective and the storage capacity usage of the physical storage units 108 is the secondary objective. In general, the method 200 can be modified to optimize the assignment of virtual machines 112 among the host computing devices 110 and the virtual disks 114 among the physical storage units 108 in this second scenario by effectively performing the discrete optimization process of part 226 before instead of after the discrete optimization process of part 218. Such a modified method is now described in detail.

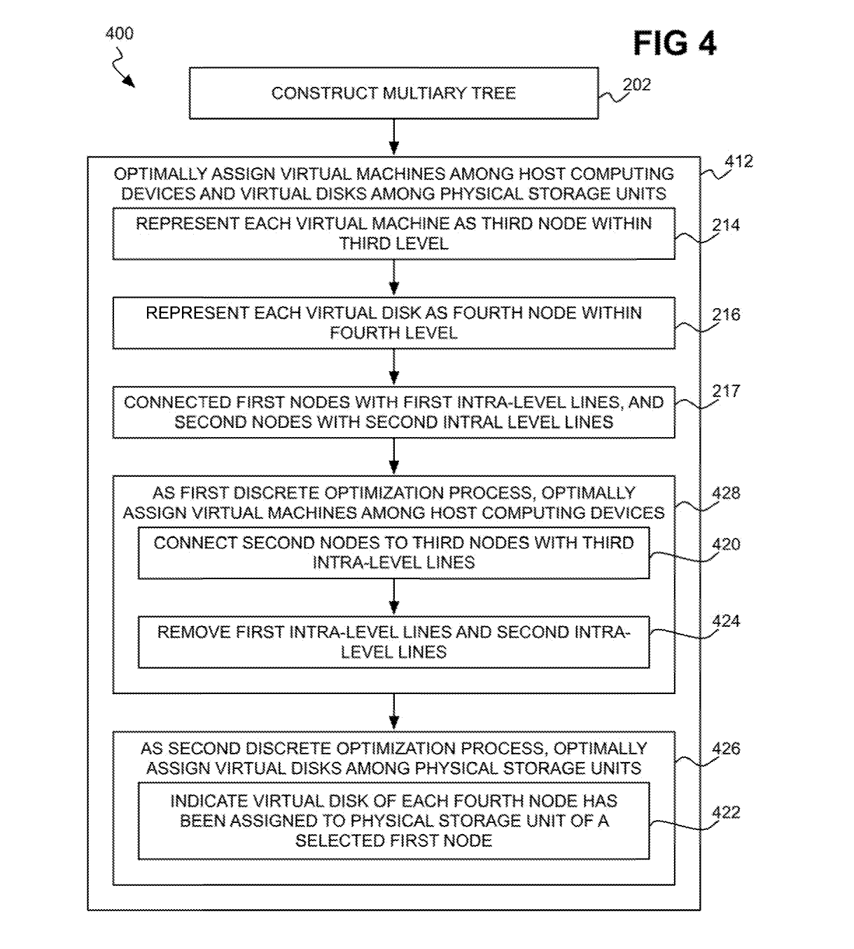

FIG. 4 shows an example method 400 for optimizing the assignment of virtual machines 112 among the host computing devices 110 and the virtual disks 114 among the physical storage devices 108 using the multiary tree 300, in the scenario in which optimal usage of the host computing devices 110 is the primary objective and storage capacity usage of the physical storage units 108 is the secondary objective. Like the method 200, the method 400 can be implemented as one or more computer programs stored on a computer-readable data storage medium and executable by a processor. The processor can be part of a computing device, such as one of the host computing devices 110, or another computing device.

The multiary tree 300 is constructed (202) in the method 400 as has been described above in relation to the performance of part 202 in the method 200, and which has been depicted by example in FIG. 3A. The virtual machines 112 are optimally assigned among the host computing devices 110 and the virtual disks 114 of the virtual machines 112 are optimally assigned among the physical storage units 108 using the multiary tree 400 (412), where optimal usage of the host computing devices 110 is the primary objective and storage capacity usage of the physical storage units 108 is the secondary objective. This first entails adding nodes within the multiary tree 300 to represent the virtual machines 112 and the virtual disks 114, and interconnecting these nodes.

As such, each virtual machine 112 is represented as a third node 312 within a third level 302C of the multiary 300 immediately below the second level 302B (214) in the method 400 as has been described above in relation to the method 200. Each virtual disk 114 is represented as a fourth node 314 within a fourth level 302D immediately below the third level 302C (214) in the method 400 as has been described above in relation to the method 200. The third nodes 312 are connected to the fourth nodes 314 with second inter-level lines 328 in accordance with the relationships between the virtual machines 112 and the virtual disks 114 (217) in the method 400 as has been described above in relation to the method 200. As such, FIG. 3B shows the example multiary tree of FIG. 3A after parts 214, 216, and 217 of the method 400 have been performed no differently than after these parts 214, 216, and 217 have been performed within the method 200.

In a first discrete optimization process, the virtual machines 112 are optimally assigned among the host computing devices 110 without assigning the virtual disks 114 among the physical storage units 108 (418), using and extending the multiary tree 300. In general, the assignment process of part 412 includes two discrete optimization processes. The optimization processes are discrete in that they are performed separately, where one process is first performed, and then the other process is performed.

The first discrete optimization process assigns the virtual machines 112 optimally among the host computing devices 110, but does not—preliminarily or otherwise—assign the virtual disks 114 an the physical storage units 108 due to the primary and secondary objectives of the scenario that the method 400 reflects. Because the primary objective is optimal usage of the host computing devices 110, the foremost consideration is assigning, the virtual machines 112 among the host computing devices 110. As such, the first discrete optimization process assigns the virtual machine 112 among the host computing devices 110 so that this objective is primarily met. As part of this process, the virtual disks 114 do not have to be assigned among the physical storage units 108, and thus no such assignment—even a preliminary assignment—has to be performed.

The first discrete optimization process in the method 400, as in the method 200, can be an opportunity index approach in which a number of parameters and constraints are considered in optimally assigning the virtual machines 112 among the host computing devices 110. The parameters and constraints can include those described above in relation to the method 200. In the description that follows, the same assumptions are made about the physical instruction 102 and the virtual topology 104 that were made in the description of the method 200 above.

As an example of such an opportunity index approach, the result of this first discrete optimization process is that the virtual machines 112A and 112C are placed on the host computing device 110C, and the virtual machine 112B is placed on, the host computing device 110D. The virtual disks 114 of these virtual machines 112 are not yet placed on the physical storage units 108. This is because, as noted above, the virtual machines 112 can be and thus are assigned among the host computing devices 110 without having to assign the virtual disks 114 among the physical storage units 108.

Performance of the first discrete optimization process in the method 400 uses the multiary tree 300 that has been constructed to navigate among the nodes 308, 310, 312, and 314 to obtain information regarding the physical storage units 108, the host computing devices 110, the virtual machines 112, and the virtual disks 114 as in the method 200 as described above. As such, the first discrete optimization process in the method 400, similar to the method 200, takes into account the first intra-level lines 324 connecting the first nodes 308 and/or the second intra-level lines 326 connecting the second nodes 310. As the virtual machines 112 are assigned to the host computing devices 110, the multiary tree 300 is extended and updated to reflect these mappings.

The first discrete optimization process extends the multiary tree 300 as follows. The second nodes 310 representing the host computing devices 110 are connected to the third nodes 312 representing the virtual machines 112 in accordance with the mapping of the virtual machines 112 to the host computing devices 110, via third inter-level lines 330 (420). Each third inter-level line 330 connecting a second node 310 to a third node 312 indicates that the virtual machine 112 represented by the third node 312 has been optimally assigned to the host computing device 110 represented by the second node 310.

Furthermore, the first intra-level lines 324 and the second intra-level lines 326 are removed from the multiary tree 300 (424). The first intra-level lines 324 are removed because the first discrete optimization process has optimally assigned the virtual machines 112 to the host computing devices 110. This means that mapping of the host computing devices 110 to the physical storage units 108 should not be varied, since this mapping may have been taken into consideration in optimally assigning the virtual machines 112 to the host computing devices 110. As such, the first intra-level lines 324 are correspondingly removed.

The second intra-level lines 326 are removed also because the first discrete optimization process has optimally assigned the virtual machines 112 to the host computing devices 110. As such, the second discrete optimization cannot modify these assignments. By removing the second intra-level lines 326, the second discrete optimization process is prevented from such performing such modification.

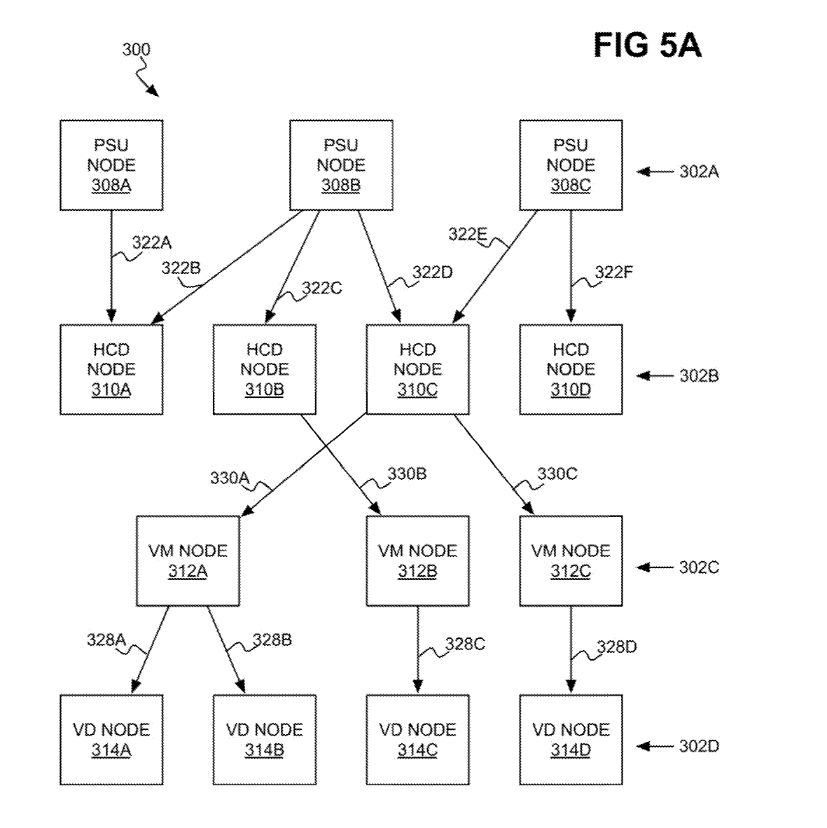

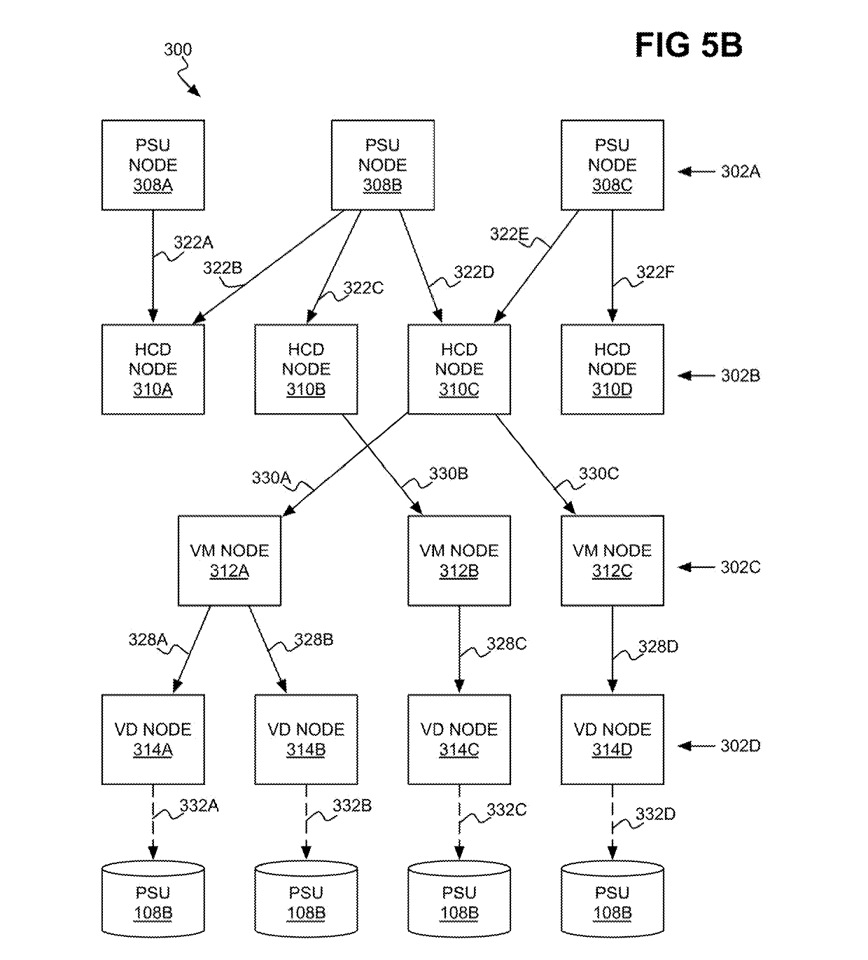

FIG. 5A shows the example multiary tree 300 of FIG. 3B after parts 418, 420, and 424 of the method 400 have been performed. The multiary tree 300 thus now includes the third inter-level lines 330, which interconnect the second nodes 310 with the third nodes 312 consistent with the optimal mappings of the virtual machines 112 to the host computing devices 110. In the example, then, the virtual machine 112A has been optimally assigned to the host computing device 110C, such that the third inter-level line 330A connects the corresponding third node 312A to the corresponding second node 310C. Similarly, the third inter-level line 330B connects the second node 310D to the third node 312B and the third inter-level line 330C connects the second node 310C to the third node 312C, because the virtual machines 112B and 112C have been optimally assigned to host computing devices 110D and 110C, respectively.

Because the virtual disks 114 have not been assigned to the physical storage units 108 yet—either preliminarily or otherwise—there are no lines in FIG. 5A similar to the lines 332 of FIG. 3C that indicate mappings of the virtual disks 114 represented by the fourth nodes 314 to the physical storage units 108. The first intra-level lines 324 of FIG. 3B have been removed from FIG. 5A. Likewise, the second intra-level lines 326 of FIG. 3B have been removed from FIG. 5A.

Referring back to FIG. 4, once the first discrete optimization process has been performed, the second discrete optimization process is performed to optimally assign the virtual disks 114 among the physical storage units 108 (426). The second discrete optimization process is performed under the additional constraint that the assignment of the virtual machines 112 among the host computing devices 110 achieved within the first discrete optimization process remains unchanged. The first discrete optimization process has already assigned the virtual machines 112 among the host computing devices 110 in an optimal manner, such that the primary objective of optimal usage of the host computing devices 110 has been satisfied. Therefore, the purpose of the second discrete optimization process is to satisfy the secondary objective of storage capacity usage of the physical storage units 108 without affecting the already achieved satisfaction of the primary objective.

Like the first discrete optimization process, the second discrete optimization process can be an opportunity index approach in which the parameters and constraints noted above are considered in optimally assigning the virtual disks 114 among the physical storage units 108, but without modifying the optimal assignments of the virtual machines 112 to the host computing devices 110. A given virtual disk 114 can be placed on any physical storage unit 108 that is connected to the host computing device 110 to which the virtual machine 112 including the given virtual disk 114 has been assigned. In this respect, the intra-level lines 322, 328, and 330 are examined within the multiary tree 300 to make this determination.

For instance, the virtual machine 112A has been assigned to the host computing device 110C that is connected to the physical storage units 108B and 108C, which means that each of the virtual disks 114A and 114B of the virtual machine 112A has to be assigned to the physical storage unit 108B or 108C. The virtual machine 112B has been assigned to the host computing device 110D that is connected to just the physical storage unit 108C, which means that the virtual disk 114C of the virtual machine 112B has to be assigned to the physical storage unit 108C. The virtual machine 112C, like the virtual machine 112A, has been assigned to the host computing device 110C that is connected to the physical storage units 108B and 108C. As such, the virtual disk 114D of the virtual machine 112C has to be assigned to the physical storage unit 108C or 108C.

As an example of an opportunity index approach, the result of the second discrete optimization process can be that the virtual disks 114A, 114B. and 114D are assigned to the physical storage unit 108B, whereas the virtual disk 114C is assigned to the physical storage unit 108C. As with the first discrete optimization process, performance of the second discrete optimization process uses the multiary tree that has been constructed to navigate among the nodes 308, 310, 312, and 314 to obtain information regarding the physical storage units 108, the host computing devices 110, the virtual machines 112, and the virtual disks 114. As the virtual disks 114 are assigned to the physical storage units 108, the multiary tree 300 is extended and updated to reflect these mappings.

The second discrete optimization process extends the multiary tree 300 as follows. Specifically, the multiary tree 300 is extended or updated to indicate the assignment of the virtual disk 114 represented by each fourth node 314 to the physical storage unit 108 of a first node 308 (422). Once the second discrete optimization process has been finished, the virtual machines 112 have been optimally assigned to the host computing devices 110 and the virtual disks 114 have been optimally assigned to the physical storage units 108 in consideration of the primary and secondary objectives of the method 400.

FIG. 5B shows the example multiary tree of FIG. 5A after parts 426 and 422 of the method 400 have been performed. The multiary tree 300 thus now includes the lines 332 corresponding to the fourth nodes 314, and which indicate the optimal mappings of the virtual disks 114 represented by the fourth nodes 314 to the physical storage units 108. In the example, the virtual disks 114A, 114B, and 114D have been optimally assigned to the physical storage unit 108B, whereas the virtual disk 114C has been optimally assigned to the physical storage unit 108C. Therefore, the lines 332A, 332B, and 332D indicate that the corresponding fourth nodes 314A, 314B, and 314D have been assigned to the physical storage unit 108B, and the line 332C indicates that the corresponding fourth node 314C has been assigned to the physical storage unit 108C.

At the end of the first discrete optimization process, the virtual topology 104 was mapped to the physical infrastructure 102 such that the virtual machines 112 have been assigned to the host computing devices 110. At the end of the second discrete optimization process, the virtual topology 104 was mapped to the physical infrastructure 102 such that the virtual disks 114 have been assigned to the physical storage units 108. The method 400 that has been described thus optimizes the assignment of virtual machines 112 among the host computing devices 110 and the virtual disks 114 among the physical storage units 108 in the scenario in which optimal usage of the host computing devices 110 is the primary objective and storage capacity usage of the physical storage units 108 is the secondary objective.

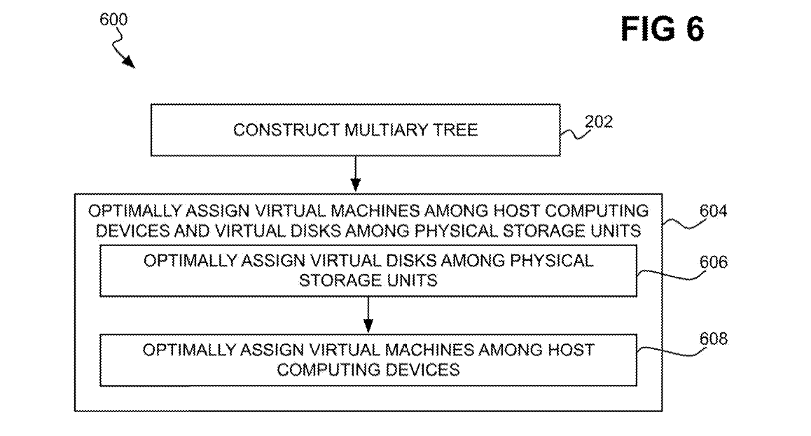

FIG. 6 shows an example method 600 for optimizing the assignment of virtual machines 112 among the host computing devices 110 and the virtual disks 114 among the physical storage units 108 using the multiary tree 300, which summarizes the methods 200 and 400 that have been described. As with the methods 200 and 400, the method 600 can be implemented as one or more computer programs stored on a computer-readable data storage medium and executed by a processor. The processor can be part of a computing device, such as one of the host computing devices 110, or another computing device.

The multiary tree 300 is constructed (202) in the method 600 as has been described above in relation to the performance of part 202 in the methods 200 and 400. The virtual machines 112 are optimally assigned among the host computing devices 110 and the virtual disks 114 of the virtual machines 112 are optimally assigned among the physical storage units 108 using the multiary tree 300 (604). Part 604 encompasses part 212 of the method 200 and part 412 of the method 400.

The optimal assignments of part 604 include two discrete optimization processes. In one discrete optimization process, the virtual disks 114 are optimally assigned among the physical storage units 108 using the multiary tree 300 (606). In another discrete optimization process, the virtual machines 112 are optimally assigned among the host computing devices 110 using the multiary tree 300 (608). Which discrete optimization process is performed first, and which discrete optimization process is performed last, can be dictated by the primary and second objectives in accordance with which the method 600 is being performed.

For example, where the primary objective is storage capacity usage of the physical storage units 108 and the secondary objective is optimal usage of the host computing devices 110, then the discrete optimization process of part 606 is performed before the discrete optimization process of part 608. This scenario corresponds to the method 200. As such, part 606 of the method 600 encompasses part 218 of the method 200 and part 608 encompasses part 226 of the method 200.

As another example, where the primary objective is optimal usage of the host computing devices 110 and the secondary objective is storage capacity usage of the physical storage units 108, then the discrete optimization process of part 608 is performed before the discrete optimization process of part 606. This scenario corresponds to the method 400. As such, part 608 of the method 600 encompasses part 418 of the method 400 and part 606 encompasses part 426 of the method 400.

We claim:

1. A method comprising:
constructing, by a processor, a multiary tree representing relationships among a plurality of physical storage units and a plurality of host computing devices; and
optimally assigning, by the processor, a plurality of virtual machines among the host computing devices and a plurality of virtual disks of the virtual machines among the physical storage units by using and extending the multiary tree, based on a plurality of constraints regarding the physical storage units, the host computing devices, the virtual machines, and the virtual disks.

2. The method of claim 1, wherein optimally assigning the virtual machines among the host computing devices and the virtual disks among the physical storage units comprises:
optimally assigning the virtual machines among the host computing devices as a first discrete optimization process; and
optimally assigning the virtual disks among the physical storage units as a second discrete optimization process.

3. The method of claim 2, wherein where a primary objective is optimal usage of capacity of the physical storage units and a secondary objective is optimal usage of the host computing devices, optimally assigning the virtual machines among the host computing devices is performed after optimally assigning the virtual disks among the physical storage units is performed,
such that the first discrete optimization process is performed after the second discrete optimization process, and
such that once the second discrete optimization process has been performed, performance of the first discrete optimization process does not and cannot alter assignment of the virtual disks among the physical storage units.

4. The method of claim 2, wherein where a primary objective is optimal usage of the host computing devices and a secondary objective is optimal usage of capacity of the physical storage units, optimally assigning the virtual disks among the physical storage units is performed after optimally assigning the virtual machines among the host computing devices is performed,
such that the second discrete optimization process is performed after the first discrete optimization process, and
such that once the first discrete optimization process has been performed, performance of the second discrete optimization process does not and cannot alter assignment of the virtual machines among the host computing devices,

5. The method of aim 1, wherein constructing the multiary tree comprises:
representing each physical storage unit as a first node within a first level of the multiary tree;
representing each host computing device as a second node within a second level of the multiary tree below the first level; and
connecting the first nodes to the second nodes with a plurality of first inter-level lines in accordance with the relationships among the physical storage units and the host computing devices, each first inter-level line connecting a given first node to a given second node indicating that the host, computing device represented by the given first node is associated with the physical storage unit represented by the given second node.

6. The method of claim 5, wherein constructing the multiary tree further comprises:
connecting the first nodes with a plurality of first intra-level lines in accordance with the relationships among the physical storage units and the host computing devices, each first intra-level connecting two first nodes indicating that the physical storage units represented by the two first nodes are shared by one of the host computing devices; and
connecting the second nodes with a plurality of second intra-level lines in accordance with the relationships among the physical storage units and the host computing devices, each second intra-level line connecting two second nodes indicating that the host computing devices represented by the two second nodes share one of the physical storage units.

7. The method of claim 5, wherein optimally assigning the virtual machines among the host computing devices and optimally assigning the virtual disks among the physical storage units comprises:
representing each virtual machine as a third node within a third level of the multiary tree below the second level;
representing each virtual disk as a fourth node within a fourth level of he multiary tree below the third level;
connecting the second nodes to the third nodes with a plurality of second inter-level lines, each second inter-level line connecting a selected second node to one or more given third nodes indicating that the virtual machines represented by the given third nodes have been assigned to the host computing device represented by the selected second node;
connecting the third nodes to the fourth nodes with a plurality of third inter-level lines, each third inter-level line connecting a given third node to one or more given fourth nodes indicating that the virtual disks represented by the given fourth nodes are associated with the virtual machine represented by the given third node; and
indicating that the virtual disk of each fourth node has been assigned to the physical storage unit of a selected first node based on the constraints.

8. The method of claim 6, wherein optimally assigning the virtual machines among the host computing devices and the virtual disks among the physical storage units comprises, where a primary objective is optimal usage of capacity of the physical storage units and a secondary objective is optimal usage of the host computing devices:
representing each virtual machine as a third node within a third level of the multiary tree below the second level;
representing each virtual disk as a fourth node within a fourth level of the multiary tree below the third level;
connecting the third nodes to the fourth nodes with a plurality of second inter-level lines, each second inter-level line connecting a given third node to one or more given fourth nodes indicating that the virtual disks represented by the given fourth nodes are associated with the virtual machine represented by the given third node;
as a first discrete optimization process, optimally assigning the virtual disks among the physical storage units and preliminarily assigning the virtual machines among the host computing devices based on the constraints and taking into account the first intra-level lines connecting the first nodes and the second intra-level lines connecting the second nodes, including:
connecting the second nodes to the third nodes with a plurality of third inter-level lines, each third inter-level line connecting a selected second node to a given third node indicating that the virtual machine represented by the given third node has been preliminarily assigned to the host computing device represented by the selected second node;
indicating that the virtual disk of each fourth node has been assigned to the physical storage unit of a selected first node;
removing the first intra-level lines connecting the first nodes; and
removing the second intra-level line connecting to the second node representing any host computing device to which no virtual machine has been preliminarily assigned.

9. The method of claim 8, wherein optimally assigning the virtual machines among the host computing devices and the virtual disks among the physical storage units further comprises, where the primary objective is optimal usage of capacity of the physical storage units and the secondary objective is optimal usage of the host computing devices, and after the first discrete optimization process has been performed,
as a second discrete optimization process, optimally assigning the virtual machines among the host computing devices based on the constraints, taking into account the second intra-level lines remaining that connect the second nodes, and without changing the physical storage unit to which each virtual disk has been assigned, including:
modifying a selected third inter-level line to change the selected second node to which the given third node is connected via the selected third inter-level line, indicating that the virtual machine represented by the given third node has been reassigned to a different host computing device as a result of the second discrete optimization process as compared to the host computing device to which the given third node was preliminarily assigned as a result of the first discrete optimization process; and
removing the second intra-level lines remaining that connect the second nodes.

10. The method of claim 6, wherein optimally assigning the virtual machines among the host computing devices and the virtual disks among the physical storage units comprises, where a primary objective is optimal usage of capacity of the physical storage units and a secondary objective is optimal usage of the host computing devices:
representing each virtual machine a third node within a third level of the multiary tree below the second level;
representing each virtual disk as a fourth node within a fourth level of the multiary tree below the third level;
connecting the third nodes to the fourth nodes with a plurality of second inter-level lines, each second inter-level line connecting a given third node to one or more given fourth nodes indicating that the virtual disks represented by the given fourth nodes are associated with the virtual machine represented by the given third node;
as a first discrete optimization process, optimally assigning the virtual machines among the host computing devices based on the constraints without assigning the virtual disks among the physical storage units, taking into account one or more of the first intra-level lines connecting the first nodes and the second intra-level lines connecting the second nodes, including:
connecting the second nodes to the third nodes with a plurality of third inter-level lines, each third inter-level line connecting a selected second node to a given third node indicating that the virtual machine represented by the given third node has been preliminarily assigned to the host computing device represented by the selected second node;
removing the first intra-level lines connecting the first nodes; and
removing the second intra-level lines connecting the second nodes.

11. The method of claim Error! reference source not found., wherein optimally assigning the virtual machines among the host computing devices and the virtual disks among the physical storage units further comprises, where the primary objective is optimal usage of capacity of the physical storage units and the secondary objective is optimal, usage of the host computing devices, and after the first discrete optimization process has been performed,
as a second discrete optimization process, optimally assigning the virtual disks among the physical storage units based on the constraints, and without changing the host computing device to which each virtual machine has been assigned, including:
indicating that the virtual disk of each fourth node has been assigned to the physical storage unit of a selected first node.

12. The method of claim 1, wherein the constraints comprise one or more of:
a service level agreement (SLA) mandating performance of one or more of the virtual machines;
an SLA mandating performance of one or more of the virtual disks;
an SLA mandating performance of one or more of the physical storage units;
a constraint mandating that the virtual disks associated with a given virtual machine are to be assigned to specified one or more of the physical storage units;
a constraint mandating that the virtual disks associated with the virtual machines assigned to a given host computing device are to be assigned to specified one or more of the physical storage units;
a constraint mandating that a first virtual disk and a second virtual disk are to be assigned to a same physical storage unit;
a constraint mandating that a first virtual disk and a second virtual disk are riot to be assigned to a same physical storage unit.

13. A non-transitory computer-readable data storage medium storing a computer program executable by a processor of a computing device to perform a method comprising:
optimally assigning a plurality of virtual machines among a plurality of host computing devices using and extending a multiary tree representing relationships among a plurality of physical storage devices and the host computing devices, as a first discrete optimization process, based on a plurality of constraints regarding the physical storage units, the host computing devices, the virtual machines, and the virtual disks; and
optimally assigning a plurality of virtual disks of the virtual machines among the physical storage units using and extending the multiary tree, as a second discrete optimization process, based on the constraints.

14. The non-transitory computer-readable data storage medium of claim 13, wherein where a primary objective is optimal usage of capacity of the physical storage units and a secondary objective is optimal usage of the host computing devices, the first discrete optimization process is performed after the second discrete optimization process, such that once the second discrete optimization process has been performed, performance of the first discrete optimization process thereafter does not and cannot alter assignment of the virtual disks among the physical storage units,
and wherein where the primary objective is the optimal usage of the host computing devices and the secondary objective is the optimal usage of the capacity of the physical storage unites, the second discrete optimization process is performed after the first discrete optimization process, such that once the first discrete optimization process has been performed, performance of the second discrete optimization process thereafter does not and cannot alter assignment of the virtual machines among the host computing devices.

15. A system comprising:
a plurality of physical storage units;
a plurality of host computing devices, where a multiary tree represents relationships among the physical storage units and the host computing devices; and
a plurality of virtual machines including a plurality of virtual disks, the virtual machines optimally assigned among the physical storage units and the virtual disks optimally assigned among the physical storage units in accordance with the multiary tree and based on a plurality of constraints regarding the physical storage units, the host computing devices, the virtual machines, and the virtual disks.
